(19) United States
(12) Patent Application Publication
(10) Pub. No.: US 2003/0204620 A1
(43) Pub. Date: Oct. 30, 2003

(54) Network device with improved routing characteristics

(75) Inventor: Lei Cheng, Austin, TX (US)

Correspondence Address: MARGER JOHNSON & McCOLLOM, P.C., 1030 S.W. Morrison Street, Portland, OR, 97205, US

(73) Assignee: Intel Corporation, Santa Clara, CA

(21) Appl. No.: 10/134,839

(22) Filed: Apr. 29, 2002

(51) Int. Cl. G06F 15/173

(52) U.S. Cl. 709/238

(57) ABSTRACT

A network device acts as a packet demultiplexor by routing network packets to two different types of networks, such as a Storage Area network (SAN) and a Local Area network (LAN). This network device sends a pointer to a stored network packet to a SAN, a LAN, or both. If the network packet is a unicast message, the network device sends a pointer to the addressee (either the SAN or LAN) and sets a counter to one. If the network packet is a multicast or broadcast message, the network device sends a pointer to both the SAN and LAN and sets a counter to two. After the SAN or LAN processes the packet, it decrements the counter. When the counter reaches zero, the system may determine that the packet can be recycled. By sending a pointer and setting a counter, the network device enables multiple networks to read a packet without having to make a copy of the packet, thereby improving speed and reducing storage requirements.

### 1. FIELD

This disclosure relates to a network device that routes packets, more particularly to a network device that routes packets to two different types of networks.

### 2. BACKGROUND

A unicast message is intended for one specific recipient. A multicast message is intended for a specific group of recipients who are members of that group. A broadcast message may be intended for all stations. Thus, if the network packet indicates it is a unicast message, the prior art network device would forward it to the correct recipient (e.g., the SAN or the LAN). If the network packet indicates it is a broadcast message, the prior art network device would forward it to both the SAN and LAN. If it were a multicast message, the prior art network device would forward it to both the SAN and LAN because the network device does not know if the SAN or LAN is a member of the specified group. This problem is compounded by the fact that there may be many different groups, each having overlapping and yet different members. Moreover, the membership of a group can change. By sending the multicast message to both the SAN and LAN, the SAN and LAN can determine for themselves if they should get the message since they know of what groups they are members. In the prior art, a device forwards a network packet to both the SAN and the LAN by making a copy of the packet and then sending one to the SAN and the other to the LAN. Speed and performance are critical in networks. Thus, there is a need for a network system that improves the speed and performance of routing packets to other networks.

### BRIEF DESCRIPTION OF THE DRAWINGS

The embodiments of the invention may be best understood by reading the disclosure with references to the drawings, wherein:

FIG. 1 is a block diagram of a network device in communication with a SAN and a LAN.

FIG. 2 is a block diagram of an embodiment of a network device that routes a network packet to a SAN and/or LAN.

FIG. 3 is a block diagram of an embodiment of a receive data structure and a receive buffer for a network device.

### DETAILED DESCRIPTION OF THE EMBODIMENTS

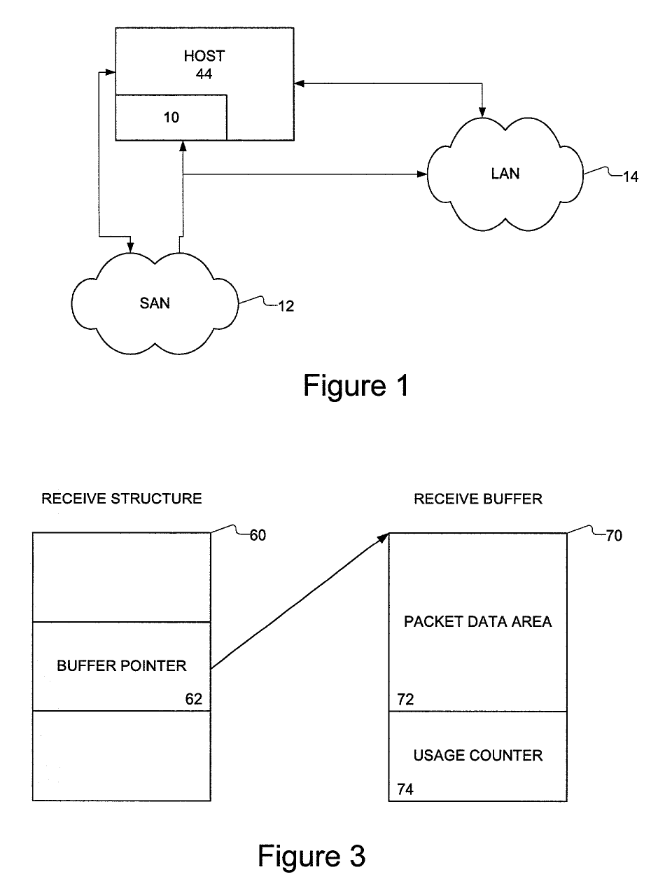

FIG. 1 shows an embodiment of a network device in communication with a SAN 12 and a LAN 14. The network device 10 may be a component of a host system 44, such as a personal computer or workstation on a network, or may stand alone. The network device and/or its host 44 may receive data packets intended for either the SAN 12 or the LAN 14 connected to the network device 10. A SAN, or storage area network, is typically a high-speed network or subnet of shared storage devices, where the storage devices are machines that contain one or more memory elements, such as disks. A LAN, or local area network, is typically a computer network that spans a relatively small area. Most LANs connect computers, workstations and other devices, and each node or device on the network can typically access data and other devices anywhere on the LAN.

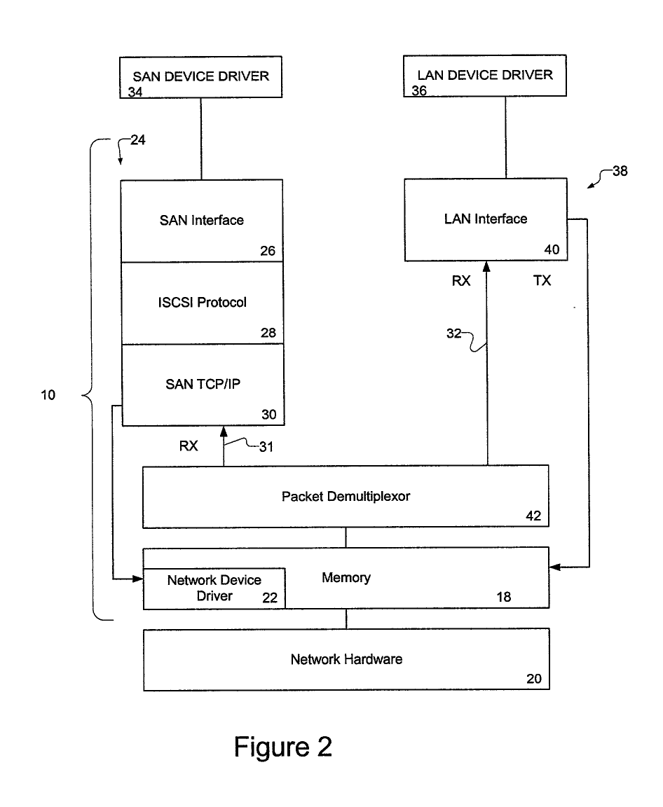

FIG. 2 is a block diagram representation of an embodiment of a network device that routes a network packet to a SAN (storage area network) and/or LAN (local area network). The network hardware 20 receives network packets. The network device 10 includes network packet demultiplexor 42. Network device driver 22 controls the network hardware 20. The network device driver 22 may be stored and operate in a data storage element such as a memory 18. A driver typically comprises a program that controls a device, acting as a translator between the device and programs that use the device. Each device usually has a specialized set of commands that only that device driver can perform.

This memory can be any kind of memory, including, but not limited to, a random access memory (RAM), fixed disk media, flexible disk media, flash memory, tape, or any other storage retrieval means, or any combination of these volatile and non-volatile memory means. As shown in FIG. 2, the memory 18 is part of the network device driver

In an embodiment, the network device 10 includes a SAN stack 24 and a LAN stack 38. More specifically, the LAN interface 38 interacts with a LAN device driver 36 in the host computer 44, and the SAN interface 26 interacts with a SAN device driver 34 in the host 44. The SAN device driver 34 and the LAN device driver 36 are software routines. The device drivers 34, 36 may operate with any appropriate operating system including, but not limited to, UNIX™ available from AT&T Corporation (which operating system was derived from UNICS—Uniplexed Information and Computer System), Linux™ (named after its creator, Linus Torvalds) and Windows® available from Microsoft Corporation. In this example embodiment, the SAN stack 24 comprises a SAN interface 26, an iSCSI protocol application 28 and a SAN TCP/IP (transmission control protocol/internet protocol) layer 30, and the LAN stack 38 is a LAN interface 38.

iSCSI is small computer systems interface (SCSI) transportable on TCP and is discussed in Internet-Draft 11 iSCSI available form the Internet Engineering Task Force (IETF). TCP/IP is a well-known set of layered protocols developed to allow cooperating computers to share resources across a network, which is used to construct the Internet. Documentation on TCP/IP can be found in RFC 2152 “A Primer On Internet and TCP/IP Tools and Utilities,” available from the Internet Engineering Task Force.

The SAN TCP/IP layer 30 handles the TCP/IP protocol and interacts with the packet demultiplexor 42 and the network device driver 22, as will be explained later. The iSCSI protocol application 28 handles the iSCSI protocol, which is a mapping of the SCSI remote procedure invocation model over the TCP. The network device 10 is comprised of firmware modules, but is not so restricted.

When the network hardware 20 receives a network packet, the network device 10 parses the header in the packet, retrieves the MAC address and compares the MAC address to the two MAC addresses stored in the network hardware 20. The MAC (Media Access Control) address is a hardware address that uniquely identifies each node on a network. One of the two MAC addresses is for the SAN connected to the network device 10 and the other is for the LAN connected to the network device 10. If the MAC address in the network packet fails to match either of the two MAC addresses, the network device 10 discards or forwards the packet because the packet was not intended for its SAN or LAN. However, if the MAC address matches one of the two MAC addresses, the packet is intended for the SAN and/or LAN to which the network device 10 is connected.

The network device 10 parses the header of the network packet to ascertain whether the packet is a unicast, multicast, or broadcast message. According to the Ethernet protocol, which is used here, each network packet has a MAC address in its header. The Ethernet protocol, developed originally by International Business Machines is documents in the Institute of Electrical and Electronic Engineers standard 802.3. There are six bytes in a MAC address. The least significant bit of the least significant byte of the MAC address is the multicast bit. In other words, bit 0 of the lowest byte is the multicast bit. If this lowest bit is set, a multicast address is indicated. If all six bytes are “OXFF” (hexadecimal), where “x” is a don't care, it is a broadcast address. Otherwise, if none of the above applies, the packet is presumed to be a unicast message.

As stated earlier, a unicast message is intended for one specific recipient. A multicast message is intended for a specific group of recipients who are members of that group. A broadcast message is intended for all stations on the network. Thus, if the network packet indicates it is a unicast message, the network device 10 forwards it through a packet demultiplexor 42 to the correct recipient (e.g., the SAN stack 24 or the LAN stack 38) specified by the matching MAC address. If the network packet indicates it is a broadcast message, the network device 10 forwards it to both the SAN and LAN. If it is a multicast message, the network device 10 forwards it to both the SAN and LAN because the network device does not know if the SAN or LAN is a member of the specified group and leaves that determination up to the SAN and LAN. In the preferred embodiment, the network device 10 does not literally send the packet to the SAN or LAN, but sends the SAN or LAN a pointer to the memory containing the packet. This actual mechanism is explained in greater detail with respect to FIG. 3.

Turning to FIG. 3, in order to “send” or “forward” the packet to the SAN or LAN, the network device driver 22 of the network device 10 sets a pointer 62 in a receive structure 60 to point to the location of the network packet in the receive buffer 70. The receive structure 60 is located in a portion of the data storage area or memory in the network device driver 22. Alternatively, the receive structure 60 can be located in any data storage area or memory that both the SAN stack 24 and the LAN stack 38 can access. The receive buffer 70 is in the memory of the network device driver 22, but may be any data storage area that is accessible to both the SAN stack 24 and the LAN stack 38. Of course, the pointer 62 could be any other representation of the location of the network packet in the receive buffer 70. For example, the network device 10 could set the address of the network packet instead of a pointer. The receive buffer 70 in this example embodiment contains two types of information. The first is the data from the packet which data has been stored in the packet data area 72 of the receive buffer 70. The second is a usage counter 74. The network device driver 22 sets the counter 74 depending on whether the packet is a unicast, multicast, or broadcast message.

If the packet is a unicast message, the network device driver 22 sets the counter 74 to one, which indicates that only one of the SAN stack 24 or LAN stack 38 is to read the packet data. By comparing the MAC address in the packet header to the MAC address of the SAN stack 24 and the MAC address of the LAN stack 38, the network device 10 may determine whether the SAN stack 24 or the LAN stack 38 should receive the packet. For example, assume the SAN stack 24 is supposed to receive the packet.

In one embodiment, the network device driver 22 sends the pointer 62 on line 31 to the SAN stack 24. The SAN stack 24 follows the pointer 62 to the receive buffer 70. The SAN stack 24 reads the counter 74. If the counter 74 is set to one or higher, the SAN stack 24 processes the packet data 72. In processing the packet data 72, the SAN stack 24 may interact with the host 44 or other devices. After processing the packet data 72, the SAN stack 24 decrements the counter 74. Since the counter 74 has decremented to zero, the SAN stack 24 may determine that no other devices will need to read the packet data 72. Accordingly, the SAN stack 24 takes an action to free up the specific receive buffer 70 pointed to by the pointer 62 for storing another packet. For example, the SAN stack 74 can erase the packet data area 72 or set the pointer 62 to a special value which indicates that the receive buffer 70 is available for storing another packet.

In another embodiment, the network device driver 22 does not send the actual pointer 62 to the SAN stack 24, but signals to the SAN stack 24 that it is permitted to look at pointer 62. At this point, in the example embodiment, the SAN stack 24 processes the packet data 72 and counter 74 in the same way as previously described for the SAN stack 24.

If the MAC address in the packet header indicates that the LAN stack 38 should receive the packet, a very similar process occurs. In other words, the network device driver 22 can send the pointer 62 on line 32 to the LAN stack 38, which comprises a LAN interface 40. At this point, the LAN stack 38 follows the pointer 62 to the receive buffer 70. The LAN stack 38 reads the counter 74. If the counter 74 is set to one or higher, the LAN stack 38 processes the packet data 72. In processing the packet data 72, the LAN stack 38 may interact with the host 44 or other devices. After processing the packet data 72, the LAN stack 38 decrements the counter 74. Since the counter 74 has decremented to zero, the LAN stack 38 may determine that no other devices will need to read the packet data 72. Accordingly, the LAN stack 38 takes an action to free up the specific receive buffer 70 pointed to by the pointer 62 for another packet. For example, the LAN stack 38 can erase the packet data area 72 or set the pointer 62 to a special value which indicates that the receive buffer 70 is available for storing another packet.

Again, in another embodiment, the network device driver 22 does not send the actual pointer 62 to the LAN stack 38, but signals to the LAN stack 38 that the LAN stack 38 is permitted to look at pointer 62 or other representation 62. At this point, in the example embodiment, the LAN stack 38 processes the packet data 72 and counter 74 in the same way as previously described for the LAN stack 38.

If the packet is a multicast or broadcast message, the preferred embodiment of the network device 10 sets the counter 74 to two. The network device driver 22 sets the pointer 62 to point to the receive buffer 70 which contains the current packet. The pointer 62 can be sent to the SAN stack 24 over line 31 and to the LAN stack 38 over line 32. Alternatively, the SAN stack 24 and the LAN stack 38 can perform alternating operations, where neither accesses the packet data 72 at the same time so as to avoid conflicts.

Various approaches may be used to dictate whether it is the SAN's or LAN's turn to access the packet data. For example, a flag can be toggled back and forth, where when the flag is set to one condition, it is the SAN's turn and when the flag is reset to another condition, it is the LAN's turn. This flag can be added to the packet data 72, to another block of the receive buffer 70, or to any other commonly accessible data storage area. In the preferred embodiment, the SAN stack 24 is designated to go first because it is usually desirable to try to optimize the SAN path.

The SAN stack 24 reads the pointer 62 and follows the pointer to the packet data 72. The SAN stack 24 processes the packet data 72 to determine whether the packet is a multicast or broadcast message. If the packet was a broadcast message, the SAN stack 24 processes the packet data 72 as an intended recipient of the packet. If the packet is a multicast message, the SAN stack 24 checks its memberships to see if it belongs to any of the groups selected to receive the packet. If the SAN stack 24 is not slated to receive the packet, it ignores the packet data. If the SAN stack 24 is an intended recipient, the SAN stack 24 processes the packet and when it finishes its processing, it decrements the counter 74 to one.

When it is the LAN stack 38's turn to access the packet data, the LAN stack 38 follows the pointer 62 to the counter 74 and checks the counter's value. Since the counter 74 is not zero (e.g., here, it is one), the LAN stack 38 checks the packet data 72 to see if it is a multicast or broadcast message. If the packet was a broadcast message, the LAN stack 38 processes the packet data 72 as an intended recipient of the packet. If the packet is a multicast message, the LAN stack 38 checks its memberships to see if it belongs to any of the groups selected to receive the packet. If the LAN stack 38 is not slated to receive the packet, it ignores the packet data and decrements the counter 74 to zero.

If the LAN stack 38 is an intended recipient, the LAN stack 38 processes the packet and when it finishes its processing, it decrements the counter 74 to zero. When the counter 74 is set to zero, the LAN stack 38 may determine that no other devices will need to read the packet data 72. Accordingly, the LAN stack 38 takes an action to free up the specific receive buffer 70 pointed to by the pointer 62 so that the buffer 70 is free to store another packet. For example, the LAN stack 38 can erase the packet data area 72 or set the pointer 62 to a special value which indicates that the receive buffer 70 is available for storing another packet.

In other embodiments, the counter 74 may be an up counter, a down-counter, a binary counter, a shift register, or any other structure which indicates which of the network stacks is to access the network packet. For example, rather than having each network stack decrement the counter after it reads the network packet, the counter can be configured so that the network stack increments the counter. Further, instead of having a counter, the network device may use two bits which are set or reset separately, one bit indicating whether the first network 24 (e.g., the SAN) is to read the packet and the other bit indicating whether the second network 38 (e.g., the LAN) is to read the packet. For example, if the counter has two bits, 00 may indicate that neither the SAN stack 24 nor the LAN stack 38 is to read the packet; 01 may indicate that the SAN stack 24 is to read the packet; 10 may indicate that the LAN stack 38 is to read the packet; and 11 may indicate that both the SAN stack 24 and the LAN stack 38 are to read the packet. Any other method of indicating which of multiple network stacks is to read the packet may be used.

As is apparent, the network device 10 advantageously does not need to make a copy of the packet in the situations of a multicast or broadcast message. Instead, the packet data 72 is stored in memory as a single copy and a pointer 62 is provided to both the SAN stack 24 and the LAN stack 38. Therefore, the SAN stack 24 and the LAN stack 38 can access the packet data 72 through the pointer 62 and by checking the value in the counter 74. Accordingly, the network device 10 is faster, is simpler and requires less memory space for multicast and broadcast packets.

In the foregoing specification, the embodiments of the invention have been described with reference to specific embodiments thereof. It will, however, be evident that various modifications and changes may be made thereto without departing from the broader spirit and scope of embodiments of the invention. For example, the reader is to understand that the specific ordering and combination of process actions described herein is merely illustrative, and the embodiments of the invention can be performed using different or additional process actions, or a different combination or ordering of process actions.

For example, instead of using a pointer 62, the network device 10 can maintain a list of packets intended for the SAN and a separate list of packets intended for the LAN, where the SAN and LAN stacks 24, 38 access their respective lists. As another example, each feature of one embodiment can be mixed and matched with other features shown in other embodiments. Similarly, while the specific example of an Ethernet packet-based local area network protocol was mentioned, any type of packet-based network with parsable headers that contain MAC information may be used.

Features and processes known to those of ordinary skill in the art of networking may similarly be incorporated as desired. Additionally and obviously, features may be added or subtracted as desired. Accordingly, the embodiments of the invention are not to be restricted except in light of the attached claims and their equivalents.

What is claimed is:

1. A network device comprising:
a network device driver to receive a network packet;
a packet demultiplexor to receive a network packet from the device driver, the packet demultiplexor having a data storage area to store the network packet;
a counter capable of being set by the packet demultiplexor to represent which of a first and second networks is to read the network packet; and
a first and second network stack to read a representation of a location of the network packet and the counter.

2. The network device of claim 1 wherein the representation is a pointer to the location of the network packet.

3. The network device of claim 1 wherein the representation is the address of the location of the network packet.

4. The network device of claim 1, wherein the packet demultiplexor sets the counter to one, indicating a unicast packet.

5. The network device of claim 1, wherein the packet demultiplexor sets the counter to two indicating that the packet is one of either a multicast or a broadcast packet and wherein the first and second network stacks are operable to determine whether the packet is a multicast or broadcast packet.

6. The network device of claim 1 wherein the first network stack includes an interface to a Storage Area Network.

7. The network device of claim 1 wherein the second network stack includes an interface to a Local Area Network.

8. The network device of claim 1 wherein the first network stack includes an iSCSI protocol application and a Storage Area Network TCP/IP application.

9. The network device of claim 1 wherein the packet demultiplexor transmits the representation to the first or second network stacks.

10. The network device of claim 1 wherein the first network stack and the second network stack alternate in accessing the network packet.

11. The network device of claim 1 wherein the network device sets the data storage area containing the network packet to be reused when the counter indicates that both first and second network stacks have finished processing the network packet.

12. The network device of claim 6 wherein the network device sets the data storage area containing the network packet to be cleared when the counter indicates that the selected first or second network stack has finished processing the network packet.

13. A method of routing an network packet, the method comprising:
receiving a network packet;
storing the network packet in a data storage area;
setting a value to represent which of the first and second network stacks is to read the network packet;
setting a representation of a location of the network packet in the data storage area.

14. The method of claim 13 wherein the representation is a pointer to the location of the network packet.

15. The method of claim 13 wherein the representation is an address of the location of the network packet.

16. The method of claim 13 wherein the network packet is a broadcast message, and the method further comprises:
permitting the first network stack to read the counter and the representation of the location of the network packet; and
changing the value to represent that the first network stack has processed the network packet, when the first network stack finishes processing the network packet.

17. The method of claim 13 wherein the network packet is a unicast message, and the method further comprises:
selecting one of either the first or second network stack to read the network packet counter;
setting the counter to indicate that one of the first and second network stacks is to read the network packet; and
changing the counter to represent that the selected first or second network stack has processed the network packet, when the selected first or second network stack finishes processing the network packet.

18. The method of claim 13 wherein the network packet is a multicast message, and the method further comprises:
setting the counter to indicate that both the first and second network stacks are to read the network packet;
changing the counter when the first network stack has processed the network packet; and
changing the counter when the second network stack has processed the network packet.

19. The method of claim 13 wherein the first network stack includes an interface to a Storage Area Network.

20. The method of claim 13 wherein the second network stack includes an interface to a Local Area Network.

21. The method of claim 19 wherein the first network stack includes an iSCSI protocol application and a Storage Area network TCP/IP application.

22. The method of claim 13 further comprising transmitting the representation to the first or second network stacks.

23. The method of claim 13 further comprising reusing the data storage area containing the network packet when the counter indicates that both first and second network stacks have finished processing the network packet.

24. The method of claim 13 further comprising clearing the data storage area containing the network packet when the counter indicates that the selected first or second network stack has finished processing the network packet.

25. An article including machine-readable code that, when executed, causes the machine to:
receive a network packet;
store the network packet in a data storage area;
set a value to represent which of the first and second network stacks is to read the network packet; and
set a representation of a location of the network packet in the data storage area.

26. The article of claim 25, wherein the machine-readable code further causes the machine to:
permit the first network stack to read the value and the representation of the location of the network packet; and
change the value to represent that the first network stack has processed the network packet, when the first network stack finishes processing the network packet.

27. The article of claim 25, wherein the machine-readable code further causes the machine to:
select one of either the first or second network stack to read the network packet data;
set the value to indicate that one of the first and second network stacks is to read the network packet; and
change the value to represent that the selected first or second network stack has processed the network packet, when the selected first or second network stack finishes processing the network packet.

28. The article of claim 25, wherein the machine-readable code further causes the machine to:
set the value to indicate that both the first and second network stacks are to read the network packet;
change the value when the first network stack has processed the network packet; and
change the value when the second network stack has processed the network packet.
